(19) United States
(12) Patent Application Publication
(10) Pub. No.: US 2023/0111745 A1
(43) Pub. Date: Apr. 13, 2023

(54) SYSTEMS AND METHODS FOR GENERATING MODELS FOR RECOMMENDING REPLACEMENT ITEMS FOR UNAVAILABLE IN-STORE PURCHASES

(71) Applicant: Kohl's, Inc., Menomonee Falls, WI (US)

(72) Inventors: Joshua Kruck, Menomonee Falls, WI (US); Kimberly Capelle, Menomonee Falls, WI (US)

(21) Appl. No.: 17/962,446

(22) Filed: Oct. 7, 2022

Related U.S. Application Data
(60) Provisional application No. 63/254,343, filed on Oct. 11, 2021.

(51) Int. Cl. G06Q 10/08; G06Q 30/06

(52) U.S. Cl. CPC G06Q 10/087; G06Q 30/0631

(57) ABSTRACT

In a “buy online, pick up in-store” service, customers place orders for items that are retrieved from store inventory and packaged for easy pick-up by the customer. Since these services typically fulfill orders from current store inventory, some items purchased by users are unavailable at the time of order fulfillment. In these circumstances, a recommendation system identifies a recommended replacement item using a trained model. The trained model includes a hierarchy of multiple sub-models, where each sub-model is configured to receive a different set of features of items as input and to generate, as output, a candidate recommended replacement item. A recommended replacement item is selected from the candidate recommendations generated by the multiple sub-models and sent for display to a user. The recommendation system receives user feedback regarding the recommended replacement item and selectively retrains one or more sub-models of the multiple sub-models based on the user feedback.

### CROSS-REFERENCE TO RELATED APPLICATION

This application claims the benefit of U.S. Provisional Patent Application No. 63/254,343, filed Oct. 11, 2021, which is incorporated herein by reference in its entirety.

### TECHNICAL FIELD

The present technology generally relates systems and methods for generating models for recommending replacement items for unavailable in-store purchases.

### BACKGROUND

Many types of businesses now offer customers “buy online, pick up in store” (BOPUS) services, in which an employee of the store picks items requested by a customer and packages them for easy pick-up by the customer. A customer selects desired items for purchase from a particular store, for example, by interacting with a web or mobile application provided by a BOPUS system. The BOPUS system transmits the order to the store, where an employee of the store is notified of the items to be retrieved from the store's inventory to fulfill the order.

Although the BOPUS system may interface with an inventory system in the store such that customers can only order items that are listed as available in the store, some items in BOPUS orders may be unavailable at the time the order is fulfilled by an employee. For example, a customer shopping in-person in the store may purchase an item between the time the BOPUS order was placed and the time the order is fulfilled. In other cases, an employee may be unable to locate an item requested in a BOPUS order (e.g., because the item was moved to an unexpected location), the employee may discover that an item is damaged or otherwise unsuitable for sale, and/or the electronic inventory was populated with inaccurate data.

### BRIEF DESCRIPTION OF THE DRAWINGS

Detailed descriptions of implementations of the present invention will be described and explained through the use of the accompanying drawings.

FIG. 1 is a block diagram illustrating an environment in which a “buy online, pick up in-store” (BOPUS) system operates in accordance with embodiments of the present technology.

FIG. 2 is a schematic diagram of an example recommendation model configured in accordance with embodiments of the present technology.

FIG. 3 is a flowchart illustrating a process for fulfilling a BOPUS order in accordance with embodiments of the present technology.

FIG. 4 is a block diagram illustrating an example processing system configured in accordance with embodiments of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology is generally directed systems and methods for generating models for recommending replacement items for unavailable in-store purchases. When an item purchased via a buy online, pick up in-store (BOPUS) service is unavailable at an intended time of order fulfillment, BOPUS systems configured in accordance with embodiments of the present technology can send the customer recommendations for one or more replacement items. The recommendations for replacement items are generated by a recommendation engine. The recommendation engine uses one or more models to select items that are likely to be available in a given store and that are likely to be of interest to the customer who placed the BOPUS order. If a customer accepts the recommendation, the BOPUS system replaces the unavailable item with the recommended item and enables fulfillment of the order. The recommendation engine can also receive customer responses to the recommendation, including acceptance or rejection of a recommendation, and use the responses to continually update and improve the recommendation models.

In some implementations, a recommendation engine identifies a first item, purchased by a user for in-store fulfillment, that is unfulfillable at a time of intended fulfillment. The recommendation engine applies a trained model to select a recommended replacement item for the first item. The trained model includes a hierarchy of sub-models, each configured to receive a different set of features of additional items as input and to generate, as output, a candidate recommended replacement item. The trained model is then configured to select the recommended replacement item(s) from the candidates generated by the sub-models. The recommendation engine sends information about the recommended replacement item(s) for display to the user and receives feedback regarding the recommended replacement. For example, the user feedback may be that the user accepts the recommended replacement item as a substitute for the first item, the user selects a different item to replace the first item, or the user cancels the order for the item. The recommendation engine uses the user feedback received from the user to selectively retrain one or more sub-models of the trained model.

Although various embodiments are described herein with respect to a buy online, pick up in-store shopping model, they may similarly apply to any of a variety of shopping modalities in which the inventory within a store is used to fulfill orders placed from outside of the store. For example, embodiments described herein may relate to both a pick up model, where customers visit the store to pick up orders packed by a store employee, and a delivery model, where a delivery service or courier retrieves the order from the store and delivers it to the customer. Similarly, embodiments herein can be implemented with respect to any type of store selling any type of product, including department stores, boutique stores, grocery stores, or restaurants or cafes.

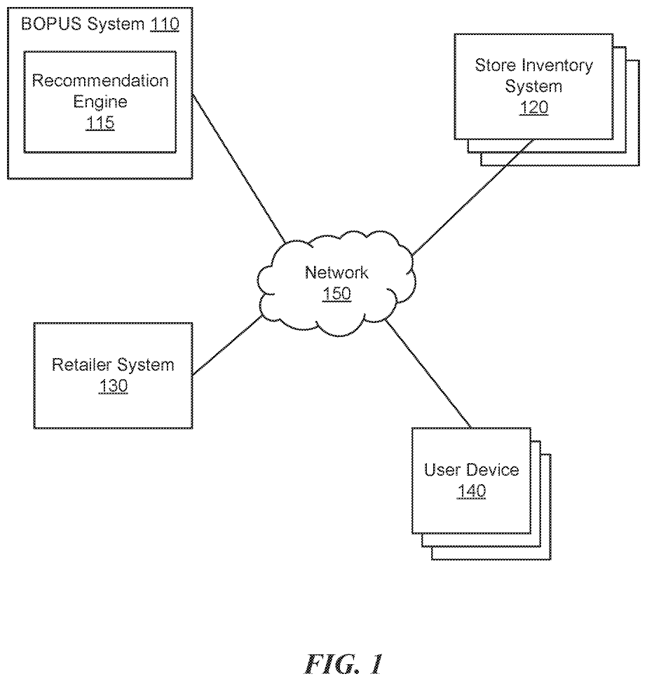

FIG. 1 is a block diagram illustrating an environment in which a BOPUS system operates according to some embodiments of the present technology. As shown in FIG. 1, the environment can include the BOPUS system 110, one or more store inventory systems 120, a retailer system 130, and one or more user devices 140, optionally communicating over a network 150 such as the Internet. In other implementations, the environment can include additional, fewer, or different components. For example, in some implementations, some or all functionality of the BOPUS system 110, store inventory system 120, and/or retailer system 130 can be combined into a single system.

The BOPUS system 110 receives orders for products sold via a physical retail store and manages fulfillment of the orders. The BOPUS system 110 can communicate with a store inventory system 120 associated with a physical store to determine items available for purchase in the store and receive customer orders for the items. When a customer orders an item for pick up at a particular store, the BOPUS system 110 can process payments or cause payment processing for the ordered item. The BOPUS system 110 manages fulfillment of the order, for example by notifying a store employee of the items ordered by a customer. The employee retrieves the items from the store and packages the items for pickup. As items are retrieved, the employee interacts with the BOPUS system 110 either to confirm that each item in an order was retrieved, or to indicate that an item is unavailable. If an item in an order cannot be fulfilled, the BOPUS system 110 recommends a replacement item to the customer. The BOPUS system 110 can communicate with the customer via any of a variety of communication channels to recommend replacement products and receive input accepting or rejecting a replacement, including short message service (SMS) messages, application notifications, emails, or phone calls.

The BOPUS system 110 can include an application, such as a web application or mobile application, that facilitates user orders. For example, the application can generate a user interface that displays available inventory, enables user filtering or searching of the inventory, receives user product selections and payment information, and confirms order details. Alternatively, the BOPUS system 110 includes an application programming interface (API) that is accessible by third-party applications, which in turn enable users to view inventory and place orders for pick up at a specified retail store. If an item in a customer's order is determined to be unavailable after the order is placed, some implementations of the BOPUS system 110 send the recommendation for a replacement product to the user via the application.

The store inventory system 120 maintains a substantially real-time record of products available in a retail store. The store inventory system 120 can interface with systems used for purchase of items, such as point-of-sale systems within a retail store and the BOPUS system 110, to automatically remove items from inventory when they are purchased. Similarly, the store inventory system 120 can be automatically or manually updated to add items when new items become available in the store's inventory. One or more inventory systems 120 can be associated with each retail store and, in some cases, different retail stores may maintain their own inventory systems even if the stores are operated by the same retail company.

The retailer system 130 is a system operated by a retailer to maintain information about products or preferences of the retailer's customers. The retailer system 130 can maintain customer accounts associated with each customer, including information about past purchases by the customer, contact information for the customer, preferred store locations visited by the customer, or other information. For example, a customer account can maintain records of any in-person or BOPUS purchases made by the customer, storing information such as the items that were purchased, the date and location of the purchase, whether the purchase was made in-store or via a BOPUS model, and any applicable attribute of the item such as brand, size, color, material, scent, or flavor. In some cases, the retailer system 130 maintains an ecommerce website, through which customers can browse the products sold by the retailer and purchase desired products for shipment to the customer. The ecommerce website can include functionality of the BOPUS system 110 in some implementations. Where a retailer provides options for customers to shop in-store, online, and via BOPUS orders, the retailer system 130 can maintain customer records that merge data associated with any of these shopping modalities.

The retailer system 130 can further maintain information about products sold through any retail stores affiliated with the retailer, whether or not the products are available in inventory in a store at any given time. The product information can include an identifier of each product (such as a SKU number), product reviews by customers who have purchased the products, and any applicable attributes of the products. In some cases, the product information can include one or more tags that identify a category or type of each product. These categories or types can be manually input or automatically derived by the retailer system 130 based, for example, on past purchases of the item. For example, some items can be tagged as “gifts” if they are commonly purchased as gifts. Other items can be tagged as being items of likely interest to different demographic groups of customers based on the demographics of customers who have previously purchased the item. Finally, the retailer system 130 can maintain information describing attributes of some products relative to other products. For example, when the products are various brands of clothing items, the retailer system 130 can maintain information comparing the sizing of one brand to the sizing of another brand (e.g., indicating that a size Medium shirt in a first brand is equivalent to a size Large shirt in a second brand).

The user device 140 is a computing device used by a customer to interact with the BOPUS system 110, such as to place a BOPUS order or to view recommended replacement products for unavailable items in a BOPUS order. The user device 140 can, for example, execute an application that enables a customer to browse items for sale at a retail store and place a BOPUS order for any desired items.

As discussed above, if an item in a BOPUS order is not available at the time the order is fulfilled, the BOPUS system 110 can recommend one or more replacement products to substitute for the unfulfillable item. Although the disclosure herein refers by way of example to generating replacements for a target item that is unfulfillable as part of a BOPUS order, similar recommendations can be generated to recommend alternatives to any of a variety of items purchased via a variety of modalities. For example, recommendations can be generated prior to any determination of whether a target item is available for fulfilment in a BOPUS order. Recommended replacement items can be presented to a user when a user adds a target item to an order cart for a BOPUS order, enabling the user to indicate one or more of the replacements that would be acceptable replacements for the target item should the target item be unavailable. Alternatively, recommended alternatives to a target item can be presented to a user to enable the user to decide to purchase one of the alternatives instead of the target item. To generate the recommendations, the BOPUS system communicates with a recommendation engine 115. In various implementations, the recommendation engine 115 is executed by the BOPUS system 110 (as illustrated in the implementation shown in FIG. 1), or by another system such as the store inventory system 120 or the retailer system 130.

In general, the recommendation engine 115 generates and applies one or more models to select one or more replacement products given features of an item in a BOPUS order that is not available at the time the order is fulfilled. The model generated by the recommendation engine 115 can include any combination of user-defined rules, derived rules, or machine learning models that are trained to generate recommendations. A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes clustering, reinforcement learning, probability distributions, decision trees, decision tree forests, and others. Models can be configured for various situations, data types, sources, and output formats.

In some implementations, the model used by the recommendation engine 115 is a neural network with multiple input nodes that receive an input data point or signal, such as an identifier or attribute of an unfulfillable item in a BOPUS order. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer (“the output layer”), one or more nodes can produce a value classifying the input that, once the model is trained, can be used to generate a replacement product recommendation. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes inputs and desired outputs. The inputs can include, for example, features of products or previously-placed BOPUS orders. The outputs can include previous recommendations given to BOPUS customers, which can be tagged with information identifying the response of the customers to the recommendations (e.g., whether the customers accepted the recommendations or canceled the item/order). As the machine learning model is trained, output from the model can be compared to the expected output and, based on the comparison, the model can be modified, such as by changing weights between nodes of the neural network or parameters of the functions used at each node in the neural network (e.g., applying a loss function). After applying each of the data points in the training data and modifying the model in this manner, the model can be trained to evaluate new data points (such as new products that cannot be fulfilled in a BOPUS order) to generate corresponding recommendations.

The model applied by the recommendation engine 115 can use any of a variety of types of data to generate the recommendations, including product search data by the customer who placed the BOPUS order or by other customers, customers' previous responses to recommended BOPUS replacements, features of products requested by customers in BOPUS orders, features of products available in the retail store in which the order was placed, or known or derived information about the products that can substitute for other products.

### Example Recommendation Model

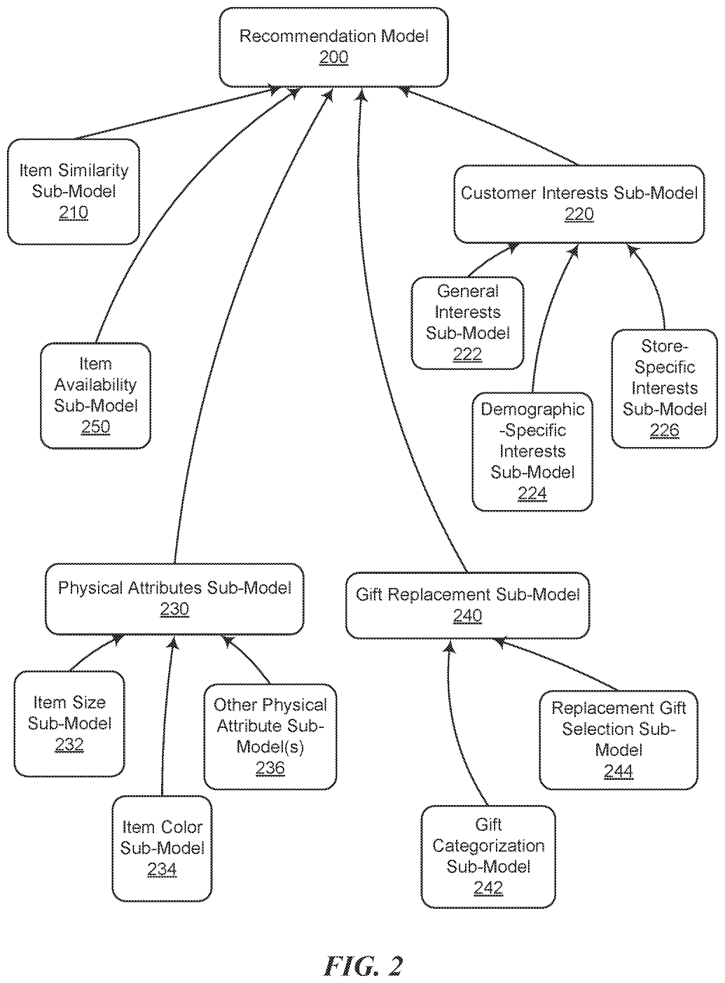

FIG. 2 is a schematic diagram illustrating an example recommendation model 200 that can be used by the recommendation engine 115 to select recommended replacement items. In general, the recommendation model 200 includes a hierarchical structure of sub-models. Within the hierarchy are multiple sub-models that are each configured to generate a candidate recommended replacement item. The recommendation model 200 inputs the candidates generated by the sub-models and selects one or more of the candidates as the recommended replacement item(s) to recommend when an ordered item cannot be fulfilled. Some sub-models in the hierarchy can include their own sub-models. In these cases, a higher-level sub-model can receive candidates generated by lower-level sub-models and select one or more candidates to pass to the next highest level in the hierarchy. These intermediate sub-models may generate their own candidate recommendations, in addition to selecting from candidates generated by lower-level sub-models.

The recommendation model 200 illustrated in FIG. 2 illustrates a hierarchical structure of several example sub-models. Different types of sub-models may be incorporated into the recommendation model 200 in other implementations, instead of or in addition to the illustrated sub-models. Furthermore, the recommendation engine 215 may not use every illustrated sub-model when generating replacement item recommendations. For example, when an unfulfillable item does not have a size, the version of the model 200 used to generate a recommended recommendation may not use the item size sub-model 232.

An item similarity sub-model 210 selects candidate replacement items based on their similarity to the target item they are replacing. The item similarity sub-model 210 can be trained to take product attributes of pairs of items as inputs and to generate, as output, a similarity score between the pairs of items. The model can be trained by any of a variety of unsupervised learning methods (e.g., using product attributes as inputs) or supervised learning methods (e.g., using customer interactions with items, via any retail channel, to label similar or dissimilar products). For example, when using customer interactions to generate training data sets for supervised learning, the recommendation engine 115 can identify sets of items with which a customer interacts during a browsing session on the retailer's ecommerce website. The recommendation engine 115 can also recommend items that are predicted to be similar to a first item and receive customer responses that are indicative of whether the items are similar. Based on the customer responses, the recommendation engine 115 modifies the similarity model to improve its predictions of similarity between items. The recommendations for similar items can be provided across any of a variety of retail channels associated with a retailer, such as on a website or in a suggestion for replacement products in a BOPUS order. The customer responses used to assess the similarity of products can include actions such as clicking through to a suggested item, accepting or rejecting a replacement item, or any other applicable action based on the format and context in which the similar item is presented.

A customer interests sub-model 220 selects candidate replacement items based on data indicating interests of a customer or set of customers, such as purchase history or search history. For example, the customer interests sub-model 220 is trained to predict that a customer would be interested in a second item, given that the customer purchased a first item. The first item can be the item that is unavailable and identified for replacement by the second item, or the first item can be a different item ordered by the customer in the same order or in a previous order. In another example, the model can be trained to predict that a customer would be interested in a given item based on items for which the customer has searched, regardless of whether the customer actually purchased the items. When training the customer interests sub-model 220, the recommendation engine 115 can use previous purchase data by any segment of customers, such as customers with similar demographic profiles to the customer who placed the BOPUS order, customers with similar purchase histories to the customer who placed the order, or customers who shop at the same store location as the customer who placed the order.

In some implementations, the recommendation engine 115 maintains multiple sub-models within the customer interests sub-model 220 to represent different subsets of users. For example, the recommendation engine 115 may maintain a general customer interests sub-model 222 (e.g., to represent purchase history across a customer base), a sub-model 224 to represent the purchase history of users with specified demographics, and a sub-model 226 to represent the purchase history of users who visit a specific retail store or a specific set of retail stores. When applying the recommendation model 200 to select a recommended replacement item, one or more of the sub-models 222, 224, 226 can be applied to generate respective candidate replacement items. The customer interests sub-model 220 selects one or more items from among the candidates generated by the sub-models 222, 224, 226, passing the selected item(s) to the top-level recommendation model 200 as the candidate(s) selected based on customer interests.

The physical attributes sub-model 230 selects a replacement item based on features that represent physical attributes of the items, such as size, color, flavor, or scent. In some implementations, the physical attributes sub-model 230 includes a plurality of sub-models that are each configured to take corresponding physical attribute features as input and to generate corresponding candidate recommendation items based on the respective physical attribute features.

For example, the physical attributes sub-model 230 can include an item size sub-model 232. When the product purchased in a BOPUS order is an item that is sold in different sizes (such as clothing items), the item size sub-model 232 is trained to predict an appropriate size for the replacement item. In some cases, the item size sub-model 232 accesses size information associated with the customer who placed the BOPUS order. The customer's size information can be derived from explicit information the user has provided (such as applicable measurements) or derived from implicit information, such as sizes of clothing items the user has purchased in the past. Additionally or alternatively, the item size sub-model 232 accesses sizing information associated with the unavailable product and sizing information associated with potential replacement products to determine the relative sizes between the ordered and recommended products. The relative sizing information can be derived from explicit information associated with the ordered and recommended products, such as size charts provided by each product's manufacturer. Relative sizing information can also be derived from other customers' purchases (e.g., customers who buy a size small in one brand frequently buy a size medium in another brand) or information provided by other customers (e.g., an indication that a given product runs small, large, or true to size).

As shown in FIG. 2, the physical attributes sub-model 230 can further include sub-models such as an item color sub-model 234 and/or other physical attribute sub-models 236 (e.g., a flavor sub-model or a scent sub-model). When the product purchased in a BOPUS order is an item that is sold in different colors, flavors, or scents, the corresponding sub-model 234, 236 is trained to predict an appropriate replacement item based, for example, on past purchases of the items with each of the different available attributes.

A gifts replacement sub-model 240 identifies when an unfulfillable item is likely to be a gift and selects an alternative gift as a recommended replacement item. As shown in FIG. 2, the gifts replacement sub-model 240 can include a gift categorization sub-model 242 and a replacement gift selection sub-model 244.

The gift categorization sub-model 242 predicts whether a target item is likely being purchased as a gift. In some cases, some items are directly assigned tags (e.g., by the retailer of the item or by users) to indicate that the items are likely to be given as gifts. The gift categorization sub-model can therefore include a set of rules that cause the recommendation engine 115 to determine an item is a gift if the item is tagged as a likely gift, or if the item is tagged as a likely gift and the item is being purchased within a specified time window near a gift-giving holiday. The gift categorization sub-model 242 can additionally or alternatively include one or more models trained to predict whether a particular item being purchased by a user is being purchased as a gift, take into account factors such as proximity to a holiday at the time of purchase, features of the item itself, how many previous purchases of the item were gifts (e.g., based on customers requesting a gift receipt for the product at the time of purchase), and/or features of previous items purchased by the customer who is placing the BOPUS order. The trained gift categorization sub-model 242 outputs a probability that a given item in a BOPUS order is a gift.

If the recommendation engine 115 determines an unfulfillable ordered item is likely to be a gift (e.g., based on the probability output by the gift categorization sub-model 242), the recommendation engine 115 can employ a replacement gift selection sub-model 244 to the recommendations generated by the recommendation engine 115 can be different from the recommendations generated for non-gift replacement products. For example, when selecting a replacement product for a gift, the recommendation engine 115 may select from a set of other items that are tagged as being popular gifts rather than from a set of items that are likely to interest the customer.

As described above, a common reason for an item to be unfulfillable in a BOPUS order is that the item was sold to an in-store customer between the time the BOPUS customer placed the order and the time the order was fulfilled. To reduce the likelihood that the replacement product will similarly sell before it can be added to a customer's order, the recommendation engine 115 can apply an item availability sub-model 250 to predict likely availability of an item. The item availability sub-model 250 can be a rule-based or machine learning-based model configured to predict item availability based factors that may be correlated with the likely availability of the item. Example factors that indicate the likely availability of an item include the number of that item in stock, an amount of time since the last sale of the item, a moving average frequency of sales of the product, or an average frequency of sales on a given day of the week or a given hour of the day. In a simple example of a rule-based item availability sub-model 250, the sub-model 250 selects a product recommendation from among any products that have a threshold number of items in stock, for example selecting a product only if there are at least five of the product available in the store inventory at the time the recommendation is generated. In another example, a rule-based item availability sub-model 250 estimates whether a product is likely to sell out in the time between the replacement recommendation being generated and the order being fulfilled based on the average frequency of sales and the number of items of the product remaining in inventory at the time the recommendation is generated, selecting product recommendations if the estimated likelihood of selling out prior to order fulfillment is less than a specified threshold. A machine learning-based item availability sub-model 250 can be trained to predict a likelihood of product availability based on these or other features of the items or the store in which the order is to be fulfilled.

The recommendation engine 115 can similarly account for other reasons that products are unfulfillable. For example, if a store employee is unable to find a product in a store at the time the employee is fulfilling a BOPUS order for the product (e.g., because the product was misplaced), the store employee may mark the product as unfulfillable in the order. To reduce the likelihood that replacement products are similarly difficult to find, the recommendation engine 115 can account for factors that may be correlated with the likelihood that an item is in a known or expected location. For example, clearance items may be more difficult to find in a retail store than regular-price items if the clearance items are moved to designated clearance racks. Accordingly, the recommendation engine 115 can apply a policy to select any products that are not likely to be located on a clearance racks as replacement products. Similarly, products that are newer to the store may be more easily located than items that have been in the store for longer periods of time, and thus the recommendation engine 115 may apply a policy to select products that were added to the store's inventory less than a threshold amount of time before the replacement recommendation is generated.

The top-level recommendation model 200 receives candidate replacement items from some or all of the sub-models and selects one or more of the candidates to output to the user as the recommended replacement item(s).

In some implementations, the recommendation model 200 selects a recommended replacement item from a set of candidates by ranking the candidates received from the sub-models. In one example, the recommendation model 200 ranks the candidates based on likelihood that the candidate items will be available at the time of fulfillment (e.g., ranking items based on the number of units available in the store at the time of recommendation selection, or ranking based on predicted likelihood of availability output by the item availability sub-model 250).

In another example, the recommendation model 200 ranks the candidates based on scores output by the sub-models, such as scores generated by the sub-models indicating a likelihood that the candidate will be a good replacement for the unfulfillable target item. The recommendation model 200 may apply a weighting function to the scores output by the sub-models before ranking the candidates based on these scores. Such weights can be set based on the category of the item in some implementations, for example based on historical data indicating that some of the sub-models perform better when selecting candidate replacement items for some product categories than for other product categories. Alternatively, the weights can be set manually by a system designer, for example to account for one sub-model tending to produce higher scores than other sub-models,

Some implementations of the recommendation model 200 select from among the candidates based on explicit rules. For example, if the gift categorization sub-model 242 predicted that an unfulfillable item is likely to be a gift, the recommendation model 200 applies a rule to output at least the candidate replacement recommended generated by the gift replacement sub-model 240.

In some implementations, the recommendation model 200 includes a top-level recommendation selection model, including a machine learning algorithm trained to select one or more recommendations from among the candidates. The machine learning algorithm can operate in conjunction with or instead of the example rules provided above.

In some implementations, at least some of the sub-models illustrated in FIG. 2 are applied to a set of items that are determined to be likely available at a time of order fulfillment, in order to select a candidate replacement from among the likely available items. For example, the recommendation model 200 first applies the item availability sub-model 250 to determine a likelihood that each of a plurality of items will be available in a store at a time of order fulfillment within the store. The sub-models within the recommendation model 200 are then applied to a set of items for which the likelihood of availability is greater than a threshold.

In addition to applying sub-models as illustrated for example in FIG. 2, some implementations of the recommendation model 200 select from candidate recommended replacement items received from external sources. For example, the recommendation engine 115 monetizes recommendations by enabling manufacturers to bid to have their products recommended. When a recommendation for a replacement product is needed, the recommendation engine 115 can operate an advertisement auction to select the product that will be recommended. Manufacturers can bid to advertise products to customers with certain attributes, to customers who ordered certain types of products, or to customers who both satisfy certain specified attributes and who ordered certain types of products. A candidate recommended replacement item generated by the advertisement auction can be added to the set of candidates generated by one or more of the sub-models of the recommendation model 200.

### Generating Recommendations for Replacement Items

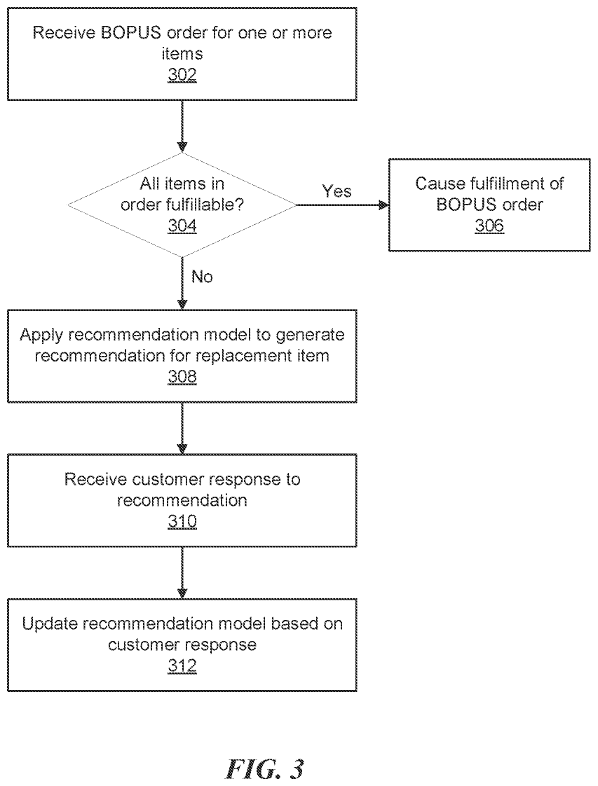

FIG. 3 is a flowchart illustrating a process for fulfilling a BOPUS order according to some implementations of the present technology. The process shown in FIG. 3 can be performed by the BOPUS system 110 of FIG. 1. Other implementations can include additional, fewer, or different steps, or can perform the steps in different orders.

As shown in FIG. 3, the BOPUS system 110 receives a BOPUS order for one or more items at block 302. The BOPUS order can specify a particular store at which an associated customer would like to pick up the order. Alternatively, the BOPUS system 110 automatically selects a store that is closest to the customer's location, that is most likely to have the items in stock, or based on other factors.

At block 304, the BOPUS system 110 determines whether all items in the order are available for fulfillment. The BOPUS system 110 can receive information indicating that an ordered item cannot be fulfilled in several ways. If the last of an item sells after the time the BOPUS order was placed but before the order is fulfilled, the BOPUS system 110 may receive a notification of the item's unavailability from the store inventory system 120. For example, the BOPUS system 110 queries the store inventory system 120 shortly before the order is to be fulfilled to determine if all items are still available in inventory. The BOPUS system 110 can additionally receive an input from the store employee who is fulfilling the order. For example, if the employee cannot find an item, determines the last of an item is damaged, or otherwise determines that an item from an order cannot be fulfilled, the employee provides an input that is received by the BOPUS system 110 as an indication that an item is unavailable.

If all items in an order were determined to be available at block 304, the BOPUS system 110 causes fulfillment of the order at block 306. For example, after an employee retrieves all items from an order, the BOPUS system 110 receives an indication that the order is ready and sends a notification to the corresponding customer. The BOPUS system 110 can also process the customer's payment for the order at block 306.

If an item was determined to be unavailable at block 304, the BOPUS system 110 applies a recommendation model at block 308 to generate at least one recommendation for a replacement item. The recommendation model, which can be the model 200 described with respect to FIG. 2, is a hierarchical model with multiple sub-models, each configured to select a candidate recommended replacement item based on different features of the item. The recommendation model can select items that are more likely to be available for fulfillment in the BOPUS order than the originally ordered item. The model can also leverage information about the customer or the products that is derived from multiple shopping modalities, including other BOPUS orders as well as in-store shopping and/or online shopping, to generate recommendations for replacement products that are likely to interest or satisfy the customer.

The BOPUS system 110 sends the recommendation to the customer who placed the order and receives, at block 310, a response from the customer to the recommendation. Recommendations can be sent, and customer responses received, via any of a variety of media including SMS messages, in-application notifications, email messages, or telephone calls. A customer may, for example, accept the recommendation to replace the unavailable item with the recommended item. If a customer accepts the recommendation, the BOPUS system 110 enables fulfillment of the order with the replacement product substituted for the original item. Other customers may request a different replacement product, either by requesting a new recommendation from the BOPUS system 110 or by explicitly searching for the desired replacement. Still other customers may cancel the item or the entire order. For example, the BOPUS system 110 generates an in-app notification to display the item that is unavailable, one or more recommended replacement items, and a selectable element to approve or reject the recommendation. The application can further allow the customer to browse for other replacement items. For example, if a user rejects the recommended replacement items, the application can display other candidate replacement items that were ranked lower by the recommendation model. Alternatively, the user can use the application to view other items sold by the store from which the user placed the original order, submitting search queries to find specific items or browsing other items by category or attribute.

Based on the customer's response to the recommendation, the BOPUS system 110 updates the recommendation model at block 312. For example, the customer's acceptance of a recommendation or cancellation of an item/order can be input to the recommendation engine 115 as positive or negative feedback, respectively. The recommendation engine 115 can retrain the recommendation model based on the user feedback in order to continually improve the model's recommendations. Retraining of the model can be triggered at periodic intervals (e.g., at a time-based interval such as once per week, or after a specified number of BOPUS orders). In other implementations, retraining is triggered if the acceptance rate of recommended replacement items (i.e., a number of times a user accepts the recommended replacement item as a percentage of the total number of recommended replacements that are output) falls below a threshold. Retraining can additionally or alternatively be triggered manually by an operator of the recommendation engine 115.

In order to retrain the recommendation model to continually improve the model's recommendations, the recommendation engine 115 selectively retrains one or more sub-models of the recommendation model. As the sub-models are designed to account for different features of items and to produce different types of candidate recommendations, selectively retraining the sub-models based on user feedback results in an improved model. Selective retraining can also be more computationally efficient than, for example, retraining a larger machine learning model that attempts to account for a larger number of features and a larger number of types of BOPUS orders.

In an example, the recommended replacement item output to the user is the candidate recommendation selected by one of the sub-models shown in FIG. 2, and the recommendation engine 115 uses any feedback related to the candidate recommendation to retrain the corresponding model that produced the candidate. If the user accepts the recommended replacement, the item is tagged as a positive training example (e.g., as an item that is interesting to users who purchased the replaced item). If the user selects a different item instead of the recommended replacement, the recommended replacement is tagged as a negative training example (e.g., as an item that is not interesting to users who purchased the replaced item) while the user-selected item is tagged as a positive training example. Similarly, if the user cancels the item or the entire order, instead of selecting a replacement item, the recommended item is tagged as a negative training example. The positive or negative training examples collected based on such user feedback are added to a model retraining set used to retrain the sub-model that selected the candidate recommendations for which the user feedback was received. In another example, the recommendation engine 115 adds such positive and/or negative training examples to a model retraining set used to retrain one or more customer interests sub-models, such as the sub-models 220, 222, or 224 shown in FIG. 2, regardless of whether the interests sub-models produced the candidate that was ultimately presented to the user.

In another example, when a user selects a different item instead of the recommended replacement item, the recommendation engine 115 identifies one or more features of the user-selected item. The one or more features can then be added to a retraining data set for a sub-model that is configured to receive the corresponding features as input. For example, if the user-selected item is a clothing item with a size, the size of the user-selected clothing item can be used to retrain the item size sub-model 232. If the user-selected item is a candle with a scent, the scent of the user-selected candle can be used to retrain an item scent sub-model.

If the user selects an item other than the recommended replacement item, the recommendation engine 115 according to another example computes a similarity score between the selected item and the recommended item based on respective feature vectors for the items that represent various attributes of the items. If the similarity score between the selected item and the recommended item is greater than a threshold similarity score, the recommendation engine 115 identifies one or more attributes for which the selected item and recommended item are most different. Information about the user's selected item can then be used to retrain the physical attributes sub-model corresponding to the most-different attribute. For example, if the recommended replacement item is a shirt in size small and the selected item is the same shirt in size medium, the recommendation engine 115 determines the recommended and selected items are similar (e.g., because they have identical attributes other than size), and determines that the size attribute of the shirts is the most different attribute. The user's selection of the size medium shirt can then be used to retrain the item size sub-model 232. In another example, if the user selects both a different size and different color of the same shirt, the recommendation engine 115 may retrain both corresponding sub-models or may select one of the sub-models for retraining based on a rule. Such a rule may indicate, for example, that the item size sub-model should be retrained and not the item color sub-model, based on an expectation that clothing size is a more important attribute to most customers than clothing colors.

As described above, some implementations of the recommendation model 200 includes a gift categorization sub-model 242, which is configured to predict whether an item ordered by a user is likely to be a gift, and a replacement gift selection sub-model 244, which is configured to select a candidate replacement item based on the likelihood that the unfulfillable item is a gift. When the gift categorization sub-model 242 predicts an unfulfillable item is a gift, feedback received with respect to a recommended replacement item can be used to retrain the replacement gift selection sub-model 244. One example implementation of the recommendation engine 115 determines that feedback related to replacement gifts should not be used to retrain other sub-models, such as the customer interests sub-model 220 or the physical attributes sub-model 230, based on a determination that users are likely to select different items as alternative gifts than they would select when replacing an item purchased for a different purpose. For example, users may be less sensitive to an item's color when purchasing a gift than they would be when purchasing items for other purposes.

In an example in which the recommendation model 200 includes a top-level recommendation selection model that is trained to select from among the candidates generated by the other sub-models, the top-level recommendation selection model can be selectively retrained based on the feedback. For example, if the user rejected the recommended replacement item output by the recommendation model, information about the actual replacement item selected by the user can be added to a retraining data set for the top-level recommendation selection model in the circumstance where the user selected one of the other candidate items generated by a sub-model.

### Example Computer System

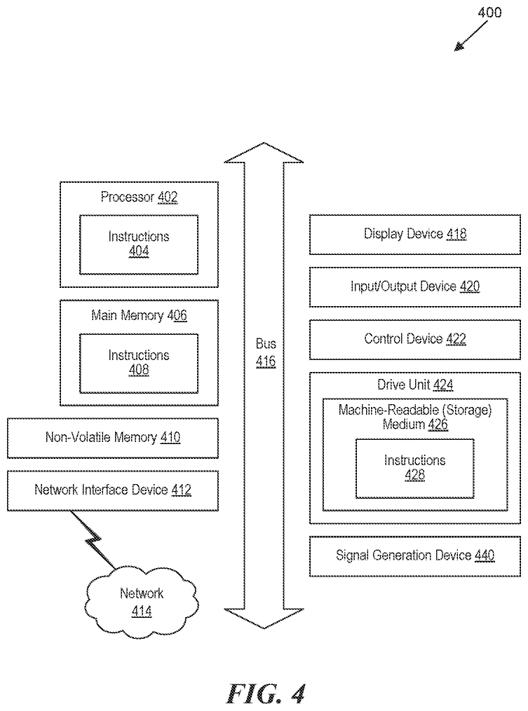

FIG. 4 is a block diagram illustrating an example of a processing system 400 in which at least some operations described herein can be implemented. For example, any of the BOPUS system 110, the store inventory system 120, the retailer system 130, or the user device 140 described above with respect to FIGS. 1 and 2 can be implemented as the processing system 400.

FIG. 4 and the discussion herein provide a brief, general description of a suitable computing environment in which the variable bias computer system can be supported and implemented. Although not required, aspects of the variable bias computer system are described in the general context of computer-executable instructions, such as routines executed by a computer, e.g., mobile device, a server computer, or personal computer. The system can be practiced with other communications, data processing, or computer system configurations, including: Internet appliances, hand-held devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through any communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme).

Portions of the system reside on a server computer, while corresponding portions reside on a client computer such as a mobile or portable device, and thus, while certain hardware platforms are described herein, aspects of the system are equally applicable to nodes on a network. In an alternative implementation, the mobile device or portable device can represent the server portion, while the server can represent the client portion.

As shown in FIG. 4, the processing system 400 may include one or more central processing units (“processors”) 402, main memory 406, non-volatile memory 410, network adapter 412 (e.g., network interfaces), video display 418, input/output devices 420, control device 422 (e.g., keyboard and pointing devices), drive unit 424 including a storage medium 426, and signal generation device 430 that are communicatively connected to a bus 416. The bus 416 is illustrated as an abstraction that represents any one or more separate physical buses, point to point connections, or both connected by appropriate bridges, adapters, or controllers. The bus 416, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 494 bus, also called “Firewire.”

In various implementations, the processing system 400 operates as part of a user device, although the processing system 400 may also be connected (e.g., wired or wirelessly) to the user device. In a networked deployment, the processing system 400 may operate in the capacity of a server or a client machine in a client-server network environment, or as a peer machine in a peer-to-peer (or distributed) network environment.

The processing system 400 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 400.

While the main memory 406, non-volatile memory 410, and storage medium 426 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 428. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 404, 408, 428) set at various times in various memory and storage devices in a computer, and that, when read and executed by one or more processing units or processors 402, cause the processing system 400 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 410, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 412 enables the processing system 400 to mediate data in a network 414 with an entity that is external to the processing system 400 through any known and/or convenient communications protocol supported by the processing system 400 and the external entity. The network adapter 412 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 412 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, or any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations can perform routines having blocks, or employ systems having blocks, in a different order, and some processes or blocks can be deleted, moved, added, subdivided, combined, and/or modified to provide alternative or subcombinations. Each of these processes, message/data flows, or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the methods and system provided herein can be applied to other systems, not necessarily the system described above. The elements, blocks and acts of the various implementations described above can be combined to provide further implementations.

Any patents and applications and other references noted above, including any that can be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system can vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects can likewise be implemented in a computer-readable medium. Accordingly, the inventors reserve the right to add additional claims after filing the application to pursue such additional claim forms for other aspects of the technology.

I/we claim:

1. A computer-implemented method comprising:
identifying, by a recommendation engine, a first item, of a set of one or more items purchased by a user for in-store fulfillment, that is unfulfillable at a time of intended fulfillment;
applying, by the recommendation engine, a trained model to select, from a set of additional items, a recommended replacement item for the first item,
wherein the trained model includes a hierarchy of multiple sub-models, each of the sub-models configured to receive a different set of features of additional items as input and to generate, as output, a candidate recommended replacement item; and
wherein the trained model is configured to select the recommended replacement item from the candidate recommended replacement items generated by the multiple sub-models;
sending, to a user device, information about the recommended replacement item for display to the user;
receiving, from an input on the user device, user feedback regarding the recommended replacement item; and
selectively retraining, by the recommendation engine, one or more sub-models of the multiple sub-models based on the user feedback.

2. The method of claim 1, wherein receiving the user feedback regarding the recommended replacement item comprises receiving a selection from the user of a different item instead of the recommended replacement item.

3. The method of claim 2, wherein selectively retraining the one or more sub-models based on the user feedback comprises:
identifying one or more features of the different item selected by the user;
identifying a sub-model of the multiple sub-models that is configured to receive, as input, a type of feature corresponding to the one or more identified features of the different item selected by the user; and
adding the one or more identified features of the different item selected by the user to a retraining data set for the identified sub-model.

4. The method of claim 1, wherein a first one of the sub-models is a gift categorization sub-model configured to output a prediction indicating whether the first item is likely to be a gift, and wherein a second one of the sub-models is a replacement gift selection sub-model configured to select a candidate replacement gift when the output of the gift categorization sub-model is a prediction that the first item is likely to be a gift.

5. The method of claim 4, wherein selectively retraining the one or more sub-models comprises retraining the replacement gift selection sub-model based on the user feedback when the output of the gift categorization sub-model is the prediction that the first item is likely to be a gift.

6. The method of claim 1, wherein the user feedback comprises an acceptance by the user of the recommended replacement item, and wherein selectively retraining the one or more sub-models based on the user feedback comprises adding the recommended replacement item to a positive training set for retraining the one or more sub-models.

7. The method of claim 1, wherein the user feedback comprises a cancellation of an order for the first item, and wherein selectively retraining the one or more sub-models based on the user feedback comprises adding the recommended replacement item to a negative training set for retraining the one or more sub-models.

8. The method of claim 1, wherein selecting the recommended replacement item from the candidate recommended replacement items comprises:
applying a ranking to the candidate recommended replacement items; and
selecting the recommended replacement item based on the ranking.

9. The method of claim 8, wherein applying the ranking comprises:
determining an expected likelihood of availability of each of the candidate recommended replacement items at the time of intended fulfillment; and
ranking the candidate replacement items based on the expected likelihood of availability.

10. The method of claim 1, wherein the trained model further comprises a recommendation selection model trained to select the recommended replacement item from among the candidate recommended replacement items, and wherein selectively retraining one or more of the sub-models comprises:
in response to determining the user selected a different item from the candidate recommended replacement items instead of the recommended replacement item, adding information about the different item selected from the candidate recommended replacement items to a retraining data set for the recommendation selection model; and
retraining the recommendation selection model based on the retraining data set.

11. The method of claim 1, further comprising:
determining the first item is unfulfillable based on a notification received from a store inventory system.

12. The method of claim 1, further comprising:
querying a store inventory system at a specified time prior to the time of intended fulfillment; and
determining the first item is unfulfillable based on a response to the query.

13. The method of claim 1, further comprising:
receiving input from a store employee indicating the first item is unfulfillable.

14. The method of claim 1, wherein applying the trained model comprises:
identifying a set of items within a store inventory having a likelihood of availability at the time of intended fulfillment that is greater than a threshold;
applying one or more of the sub-models to the identified set of items to generate respective candidate recommended replacement items.

15. The method of claim 1, wherein applying the trained model comprises:
determining, for each of the candidate recommended replacement items, a likelihood of availability of the respective candidate recommended replacement item at the time of intended fulfillment; and
selecting the recommended replacement item from the candidate recommended replacement items based on the respective likelihoods of availability.

16. A non-transitory computer-readable storage medium storing executable computer program instructions, the computer program instructions when executed by a processor causing the processor to:
identify a first item, of a set of one or more items purchased by a user for in-store fulfillment, that is unfulfillable at a time of intended fulfillment;
apply a trained model to select, from a set of additional items, a recommended replacement item for the first item,
wherein the trained model includes a hierarchy of multiple sub-models, each of the sub-models configured to receive a different set of features of additional items as input and generate, as output, a candidate recommended replacement item; and
wherein the trained model is configured to select the recommended replacement item from the candidate recommended replacement items generated by the multiple sub-models;
send, to a user device, information about the recommended replacement item for display to the user;
receive, via an input on the user device, user feedback regarding the recommended replacement item; and
selectively retrain one or more sub-models of the multiple sub-models based on the user feedback.

17. The non-transitory computer-readable storage medium of claim 16, wherein receiving the user feedback regarding the recommended replacement item comprises receiving a selection from the user of a different item instead of the recommended replacement item, and wherein selectively retraining the one or more sub-models based on the user feedback comprises:
identifying one or more features of the different item selected by the user;
identifying a sub-model of the multiple sub-models that is configured to receive, as input, a type of feature corresponding to the one or more identified features of the different item selected by the user; and
adding the one or more identified features of the different item selected by the user to a retraining data set for the identified sub-model.

18. The non-transitory computer-readable storage medium of claim 16, wherein applying the trained model comprises:
identifying a set of items within a store inventory having a likelihood of availability at the time of intended fulfillment that is greater than a threshold;
applying one or more of the sub-models to the identified set of items to generate respective candidate recommended replacement items.

19. The non-transitory computer-readable storage medium of claim 16, wherein applying the trained model comprises:
determining, for each of the candidate recommended replacement items, a likelihood of availability of the respective candidate recommended replacement item at the time of intended fulfillment; and
selecting the recommended replacement item from the candidate recommended replacement items based on the respective likelihoods of availability.

20. A replacement product recommendation system, comprising:
one or more processors; and
a non-transitory computer-readable storage medium storing instructions that, when executed by the one or more processors, cause the one or more processors to:
identify a first item, of a set of one or more items purchased by a user for in-store fulfillment, that is unfulfillable at a time of intended fulfillment;
apply a trained model to select, from a set of additional items, a recommended replacement item for the first item,
wherein the trained model includes a hierarchy of multiple sub-models, each of the sub-models configured to receive a different set of features of additional items as input and generate, as output, a candidate recommended replacement item; and
wherein the trained model is configured to select the recommended replacement item from the candidate recommended replacement items generated by the multiple sub-models;
send information about the recommended replacement item for display to the user;
receive user feedback regarding the recommended replacement item; and
selectively retrain one or more sub-models of the multiple sub-models based on the user feedback.
